(19) United States
(12) Patent Application Publication
(10) Pub. No.: US 2014/0293143 A1
(43) Pub. Date: Oct. 2, 2014

(54) TOUCH PANEL AND ELECTRONIC DEVICE

(71) Applicant: HTC CORPORATION, Taoyuan County (TW)

(72) Inventors: Tun-Chun Yang, Taoyuan County (TW); Chih-Jen Hu, Taoyuan County (TW)

(73) Assignee: HTC Corporation, Taoyuan County (TW)

(21) Appl. No.: 13/851,109

(22) Filed: Mar. 27, 2013

(51) Int. Cl. G06F 1/16

(52) U.S. Cl. CPC G06F 1/1643
USPC 349/12

(57) ABSTRACT

A touch panel and an electronic device are provided. The electronic device includes a body, a display panel and a touch panel. The display panel is disposed between the body and the touch panel, and the touch panel is adhered to the display panel. The touch panel includes a first substrate, an insulating layer and a touch sensing layer. The insulating layer and the touch sensing layer are disposed on the first substrate. The touch panel having the insulating layer has a waterproof function, and is capable of replacing a waterproof film probably required in the electronic device, so as to decrease a whole thickness of the electronic device.

### BACKGROUND

1. Technical Field

The application relates to a touch panel and an electronic device. Particularly, the application relates to a waterproof touch panel and an electronic device.

2. Related Art

In recent years, along with quick development and application of information technology, wireless mobile communication and information home appliances, in order to achieve purposes of more convenience, more compact and more humanity, input devices of many information products have been changed from a conventional keyboard or mouse to a combination of touch panel and display panel.

FIG. 1 is a cross-sectional view of a conventional electronic device using a touch panel. Referring to FIG. 1, the electronic device 10 uses an organic light emitting display panel 110. Since the organic light emitting display panel 110 has a poor moisture tolerance, a waterproof film 120 is required to be disposed on the organic light emitting display panel 110. However, usage of the waterproof film 120 increases a whole thickness of the electronic device 100.

### SUMMARY

The application is directed to a touch panel, which has a waterproof function.

The application is directed to an electronic device, which has thinner thickness.

The application provides a touch panel including a first substrate, an insulating layer and a touch sensing layer. The insulating layer and the touch sensing layer are disposed on the first substrate.

The application provides an electronic device including a body, a display panel and a touch panel. The display panel is disposed between the body and the touch panel, and the touch panel is adhered to the display panel.

According to the above descriptions, in the touch panel and the electronic device of the application, since the touch panel has the waterproof function, the electronic device is unnecessary to use a waterproof film, which decreases a whole thickness of the electronic device.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a conventional electronic device using a touch panel.

FIG. 2A is a cross-sectional view of a touch panel according to an embodiment of the invention.

FIG. 2B is a cross-sectional view of an insulating layer of a touch panel according to another embodiment of the invention.

FIG. 3 is a partial top view of the touch panel of FIG. 2A.

FIG. 4 is a cross-sectional view of an electronic device according to an embodiment of the invention.

FIG. 5 is a cross-sectional view of an electronic device according to another embodiment of the invention.

FIG. 6 is a cross-sectional view of an electronic device according to still another embodiment of the invention.

FIG. 7 is a cross-sectional view of an electronic device according to yet another embodiment of the invention.

FIG. 8 is a cross-sectional view of a touch panel according to still another embodiment of the invention.

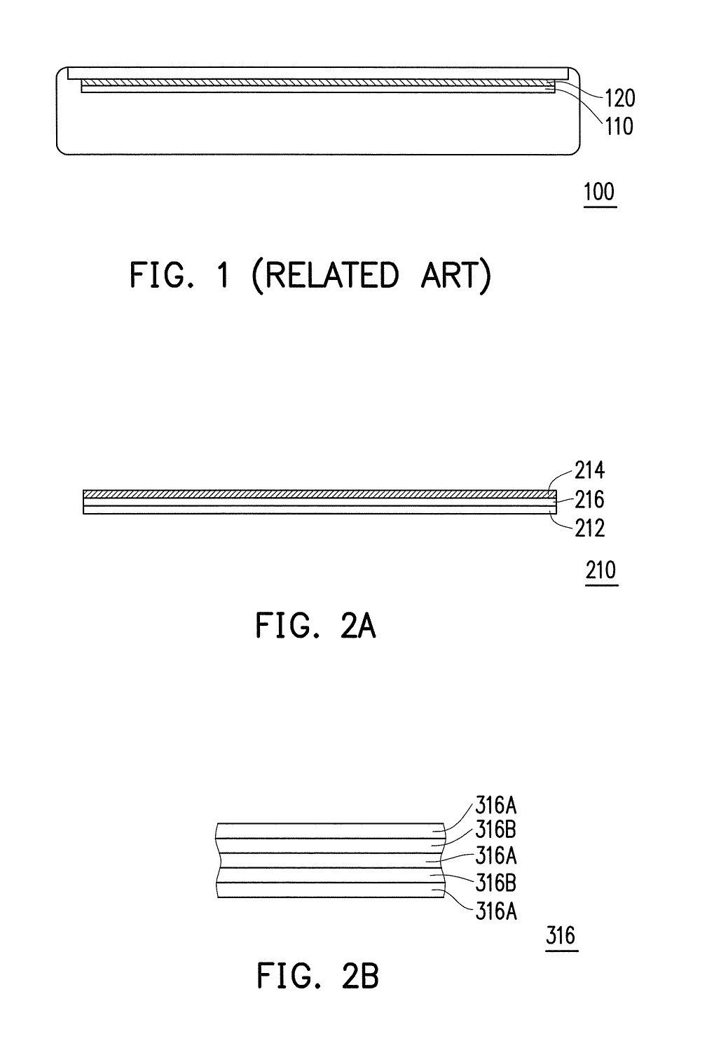

### DETAILED DESCRIPTION OF DISCLOSED EMBODIMENTS

FIG. 2A is a cross-sectional view of a touch panel according to an embodiment of the invention. Referring to FIG. 2A, the touch panel 210 of the present embodiment includes a first substrate 212, an insulating layer 216 and a touch sensing layer 214, where the insulating layer 216 and the touch sensing layer 214 are disposed on the first substrate 212. In the present embodiment, the insulating layer 216 is disposed on the first substrate 212, and the touch sensing layer 214 is disposed on the insulating layer 216. In other embodiments, the touch sensing layer 214 can be disposed on the first substrate, and the insulating layer 216 can be disposed on the touch sensing layer 214. Since the touch panel 210 applies the insulating layer 216, the touch panel 210 also has a waterproof function as that does of a general waterproof film. A material of the first substrate 212 can be polyethylene terephthalate (PET) or other material, and besides configuring the insulating layer 216, other types of waterproofing treatments can also be applied to strengthen the capability of isolating moisture. The insulating layer 216 of the present embodiment is, for example, a single inorganic material layer, though the insulating layer 316 of FIG. 2B includes a plurality of inorganic material layers 316A and a plurality of organic material layers 316B stacked in interlace. A material of the inorganic material layer 316A is, for example, silicon nitride, silicon oxide or other suitable materials, and the inorganic material layer 316A has good performance in isolating moisture and oxygen. The organic material layer 316B has better flexibility, which avails decreasing a chance of cracking when the inorganic material layer 316A is bended. In the present embodiment, since the insulating layer 216 and the touch sensing layer 214 are simultaneously disposed on the first substrate 212, compared to the conventional technique of additionally using the waterproof film 120, the thickness of the touch panel 210 of the present embodiment is thinner.

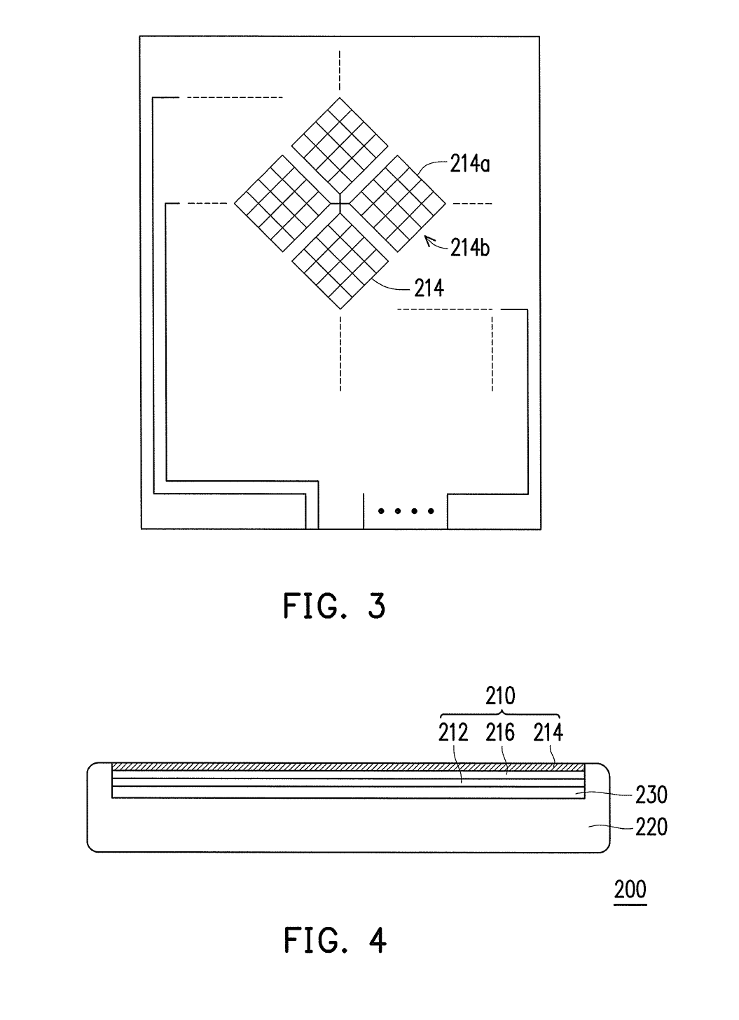

FIG. 3 is a partial top view of the touch panel of FIG. 2A. Referring to FIG. 3, an electrode pattern 214b of the touch sensing layer 214 of the present embodiment is composed of a metal mesh 214a. Compared to a commonly used electrode pattern composed of indium tin oxide or other transparent conductive materials, the electrode pattern 214b composed of the metal mesh 214a has a lower resistance value, which improves sensitivity and accuracy of touch sensing. Certainly, the touch sensing layer composed of indium tin oxide or other transparent conductive materials or other touch sensing layers can also be applied to the touch panel of other embodiment of the invention.

FIG. 4 is a cross-sectional view of an electronic device according to an embodiment of the invention. Referring to FIG. 4, the electronic device 200 of the present embodiment includes a body 220, a display panel 230 and a touch panel 210 of FIG. 2A. The display panel 230 is disposed between the body 220 and the touch panel 210, and the touch panel 210 is adhered to the display panel 230. In the present embodiment, the insulating layer 216 is disposed on the first substrate 212, and the touch sensing layer 214 is disposed on the insulating layer 216. In other embodiments, the touch sensing layer 214 can be disposed on the first substrate 212, and the insulating layer 216 can be disposed on the touch sensing layer 214. In the touch panel 210, since the insulating layer 216 and the touch sensing layer 214 are simultaneously disposed on the first substrate 212, the touch panel 210 can provide the waterproof function to the electronic device 200, and it is unnecessary to use an extra waterproof film, so as to decrease the whole thickness of the electronic device 200.

The display panel 230 of the present embodiment can be an organic light emitting display panel, a liquid crystal display (LCD) panel or other types of display panel. The touch panel 210 having the waterproof function can isolate moisture to protect the organic light emitting display panel, the LCD panel or other types of display panel from being affected by moisture. Moreover, the organic light emitting display panel may have a flexible substrate or a glass substrate. In addition, the electronic device 200 of the present embodiment can be a mobile phone, a tablet PC or other electronic device having a waterproof requirement.

Other embodiments are provided below for descriptions. It should be noticed that reference numbers of the components and a part of contents of the aforementioned embodiment are also used in the following embodiment, wherein the same reference numbers denote the same or like components, and descriptions of the same technical contents are omitted. The aforementioned embodiment can be referred for descriptions of, the omitted parts, so that detailed descriptions thereof are not repeated in the following embodiment.

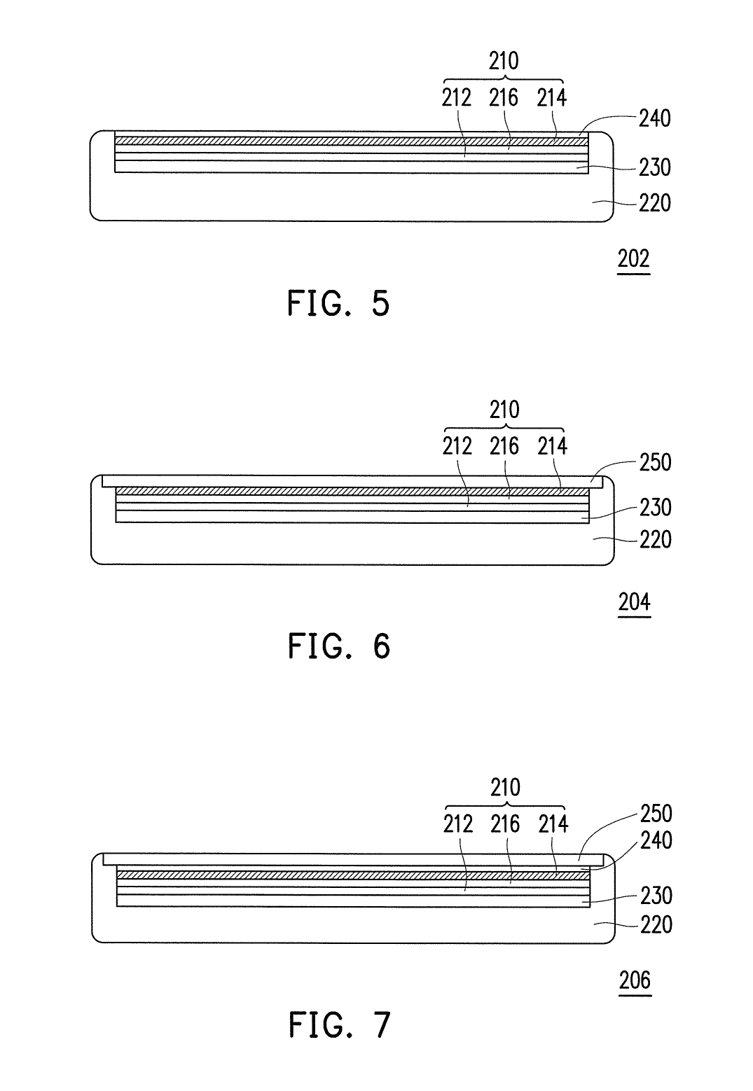

FIG. 5 is a cross-sectional view of an electronic device according to another embodiment of the invention. Referring to FIG. 5, a difference between the electronic device 202 of the present embodiment and the electronic device 200 of FIG. 4 is that the electronic device 202 of the present embodiment further includes a polarizer 240. The touch panel 210 is disposed between the display panel 230 and the polarizer 240. The polarizer 240 is, for example, a circular polarizer. When the display panel 230 is the organic light emitting display panel, since the organic light emitting display panel has a plurality of metal lines, when the sunlight directly irradiates the display panel 230, a user is liable to see the light reflected by the metal lines of the organic light emitting display panel. Therefore, the circular polarizer 240 is used to resolve the problem of light reflection. Moreover, when the touch panel 210 adopts the metal mesh, the touch panel 210 probably has a phenomenon of moiré. Similar, by using the polarizer 240, the problem of moiré can also be resolved. In detail, after an ambient light passes through the polarizer 240, the ambient light is filtered to only remain a right circularly polarized light, and the right circularly polarized light is reflected by the touch panel 210 or the display panel 230 to form a left circularly polarized light, so that it cannot passes through the polarizer 240.

FIG. 6 is a cross-sectional view of an electronic device according to still another embodiment of the invention. Referring to FIG. 6, a difference between the electronic device 204 of the present embodiment and the electronic device 200 of FIG. 4 is that the electronic device 204 of the present embodiment further includes a transparent cover 250. The touch panel 210 is disposed between the display panel 230 and the transparent cover 250. The transparent cover 250 can protect the display panel 230 and the touch panel 210 there below. A scratch-resistant treatment can be selectively performed on the transparent cover 250 to improve durability.

FIG. 7 is a cross-sectional view of an electronic device according to yet another embodiment of the invention. Referring to FIG. 7, a difference between the electronic device 206 of the present embodiment and the electronic device 202 of FIG. 5 is that the electronic device 206 of the present embodiment further includes a transparent cover 250. The polarizer 240 is disposed between the touch panel 210 and the transparent cover 250.

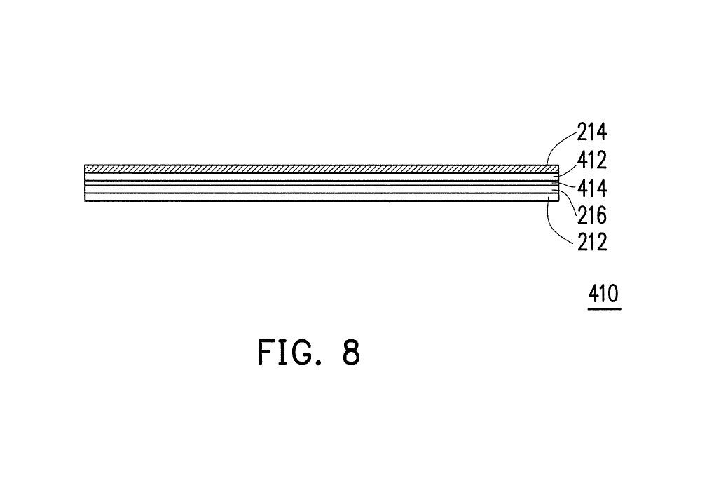

FIG. 8 is a cross-sectional view of a touch panel according to still another embodiment of the invention. Referring to FIG. 8, a difference between the touch panel 410 of the present embodiment and the touch panel 210 of FIG. 2A is that the touch panel 410 of the present embodiment further includes a second substrate 412 and an adhesive layer 414. The second substrate 412 is disposed between the touch sensing layer 214 and the insulating layer 216. The adhesive layer 414 is disposed between the second substrate 412 and the insulating layer 216. When the touch panel 410 of the present embodiment is fabricated, the touch sensing layer 214 is first formed on the second substrate 412, and the insulating layer 216 is formed on the first substrate 212. Then, the adhesive layer 214 is used to adhere the second substrate 412 to the insulating layer 216. In other embodiments, positions of the touch sensing layer 214 and the insulating layer 216 can be exchanged. In detail, the insulating layer 216 is formed on the second substrate 412, and the adhesive layer 414 is used to adhere the second substrate 412 to the touch sensing layer 214. The touch panel 410 of the aforementioned embodiment can also be applied to the electronic devices of FIG. 4 to FIG. 6 or other suitable electronic devices, and the insulating layer 216 can be a single layer or a multilayer design.

In summary, in the touch panel and the electronic device of the application, the touch panel have both of the insulating layer and the first substrate, and both of the insulating layer and the first substrate can block the moisture. Therefore, the electronic device using the touch panel is unnecessary to use a waterproof film, so as to decrease the whole thickness of the electronic device. Moreover, the electrode pattern of the touch panel may adopt a deign of metal lines with higher touch accuracy and faster response speed, and a polarizer disposed in front of the touch panel is used to decrease the interference caused by the metal lines when the user views displayed images.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch panel, comprising:
a first substrate;
an insulating layer, disposed on the first substrate; and
a touch sensing layer, disposed on the first substrate.

2. The touch panel as claimed in claim 1, wherein the insulating layer is a single inorganic material layer or a plurality of inorganic material layers and a plurality of organic material layers stacked in interlace.

3. The touch panel as claimed in claim 1, further comprising:
a second substrate, disposed between the touch sensing layer and the insulating layer; and
an adhesive layer, disposed between the second substrate and the first substrate.

4. The touch panel as claimed in claim 1, wherein an electrode pattern of the touch sensing layer is composed of metal mesh.

5. An electronic device, comprising:
a body;
a display panel;
a touch panel, wherein the display panel is disposed between the body and the touch panel, the touch panel is adhered to the display panel, and the touch panel comprises:
a first substrate;
an insulating layer, disposed on the first substrate; and
a touch sensing layer, disposed on the first substrate.

6. The electronic device as claimed in claim 5, wherein the insulating layer is a single inorganic material layer or a plurality of inorganic material layers and a plurality of organic material layers stacked in interlace.

7. The electronic device as claimed in claim 5, wherein the touch panel further comprises:
a second substrate, disposed between the touch sensing layer and the insulating layer; and
an adhesive layer, disposed between the second substrate and the first substrate.

8. The electronic device as claimed in claim 5, wherein an electrode pattern of the touch sensing layer is composed of metal mesh.

9. The electronic device as claimed in claim 5, further comprising a polarizer, wherein the touch panel is disposed between the display panel and the polarizer.

10. The electronic device as claimed in claim 9, further comprising a transparent cover, wherein the polarizer is disposed between the touch panel and the transparent cover.

11. The electronic device as claimed in claim 5, further comprising a transparent cover, wherein the touch panel is disposed between the display panel and the transparent cover.

12. The electronic device as claimed in claim 5, wherein the display panel is an organic light emitting display panel.

13. The electronic device as claimed in claim 12, wherein the organic light emitting display panel has a flexible substrate or a glass substrate.
